(19) United States
(12) Patent Application Publication
(10) Pub. No.: US 2024/0311768 A1
(43) Pub. Date: Sep. 19, 2024

(54) SYSTEM AND METHOD FOR ORGANIZING A VIRTUAL INTERVIEW

(71) Applicant: Kishore Daggubati, Danville, CA (US)

(72) Inventor: Kishore Daggubati, Danville, CA (US)

(21) Appl. No.: 18/184,675

(22) Filed: Mar. 16, 2023

(51) Int. Cl. G06Q 10/1053; G06Q 10/1093

(52) U.S. Cl. CPC G06Q 10/1053; G06Q 10/1095; H04L 65/403

(57) ABSTRACT

A system for organizing a virtual interview comprises a server for creating first and second virtual room, creating agenda for first set of users and second user wherein agenda comprises plurality of interactive sessions with assigned time slots, communicating agenda and unique virtual address with users, hosting first and second virtual room and providing users access to first virtual room for enabling interaction between second user and first set of users. The server is configured for notifying first set of users, conclusion of interaction between active user and second user upon receiving instruction from active user and providing access to subsequent user from first set of users, into first virtual room for establishing interaction with second user and transferring host controls of first virtual room and second virtual room from one active user to subsequent active user upon receiving an instruction from former active user.

### BACKGROUND

### Field of the Invention

The disclosed subject matter relates to the field of video conferencing. More particularly, but not exclusively, the subject matter relates to the field of organizing a virtual interview.

### BRIEF STATEMENT OF THE PRIOR ART

Conducting job interviews have been a critical step in the hiring process. Companies have been investing a lot of their energy and time on conducting interviews so that they can find the right person for the job. Traditionally, interviews have been conducted in person. In-person interviews have quite some challenges, like involving travel for both parties as they need to be present at the location for the interview. In addition, all concerned parties are required to be present at the scheduled time for the interview, failing which the interview may not progress as planned and may not be effective. Furthermore, with recent COVID pandemic, owing to safety reasons, social distancing has become one of the constraints and remote work has become a norm for most of the companies.

In such situations where conducting face to face interviews are now rare, an alternate approach is to go digital by organizing virtual interviews. Virtual interviews offer great flexibility in comparison to a face-to-face interview like increased convenience and reduced travel costs. Furthermore, conducting virtual interviews are more time efficient. All the concerned parties can join the virtual interview from any location thereby providing greater flexibility to everyone. Furthermore, companies can now reach out to talents without worrying about location of the candidates.

Currently, there have been video calling applications that enable people to connect remotely. However, none of the already available applications are designed for organizing an interview and neither can any of the existing application be customized for the purposes of an interview.

In view of the foregoing, there is a need for a system that is configured to provide a virtual interview having an in-person interview experience without affecting the final goal, which is hiring the right candidate.

### SUMMARY OF THE INVENTION

An embodiment provides a system for organizing a virtual interview. The system comprises of a server comprising at least one processor module configured for creating a first virtual room, and a second virtual room associated with the first virtual room, creating an agenda for a second user and a first set of users based on inputs received by at least one user among the first set of users, wherein the agenda comprises of at least one interactive session wherein each interactive session has at least one time slot assigned to the second user and at least one user among the first set of users. The server is further configured for creating a unique virtual address for the first virtual room and the second virtual room, wherein the virtual address enables the second user and at least one user among the first set of users to access at least the second virtual room, wherein access to the second virtual room is for a respective time slot for the second user and at least one user among the first set of users, and communicating the agenda and the unique virtual address with the second user and the first set of users. The server is further configured for hosting the first virtual room and the second virtual room, providing at least one user among the first set of users with respective assigned time slot access to the first virtual room, providing the second user access to the second virtual room upon establishing a connection between a second data processing system and the server, wherein the second data processing system is associated to the second user. The server is further configured for providing access to the second user access to the first virtual room upon establishing a connection between a first data processing system and the second data processing system and receiving a first instruction from at least one active user among the first set of users to enable interaction between the active user and the second user, wherein the first data processing system is associated to at least one user among the first set of users, notifying at least one subsequent user among the first set of users of conclusion of interaction between the active user and the second user upon receiving a second instruction from the active user and thereby providing access to at least one subsequent user among the first set of users, into the first virtual room to establish interaction with the second user, wherein the active user provides access to the at least one subsequent user among the first set of users with the assigned time slot to join the first virtual room and status of the subsequent user among the first set of users, upon entering the first virtual room, changes to active user, and transferring host controls of the first virtual room and the second virtual room from one active user to subsequent active user upon receiving a third instruction from at least one former active user.

### BRIEF DESCRIPTION OF DRAWINGS

Embodiments are illustrated by way of example and not limitation in the figures of the accompanying drawings, in which like references indicate similar elements and in which:

FIG. 1 illustrates a block diagram of a system 100 for organizing a virtual interview.

FIG. 2 illustrates a block diagram of a first data processing system 102.

FIG. 3 illustrates a block diagram of a second data processing system 102.

FIG. 4 is a block diagram illustrating the architecture of the server 112.

FIGS. 5A-5C illustrate a flowchart 500 of the working of the system 100.

FIG. 6 illustrates a flowchart 600 of process of rating by the system 100.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

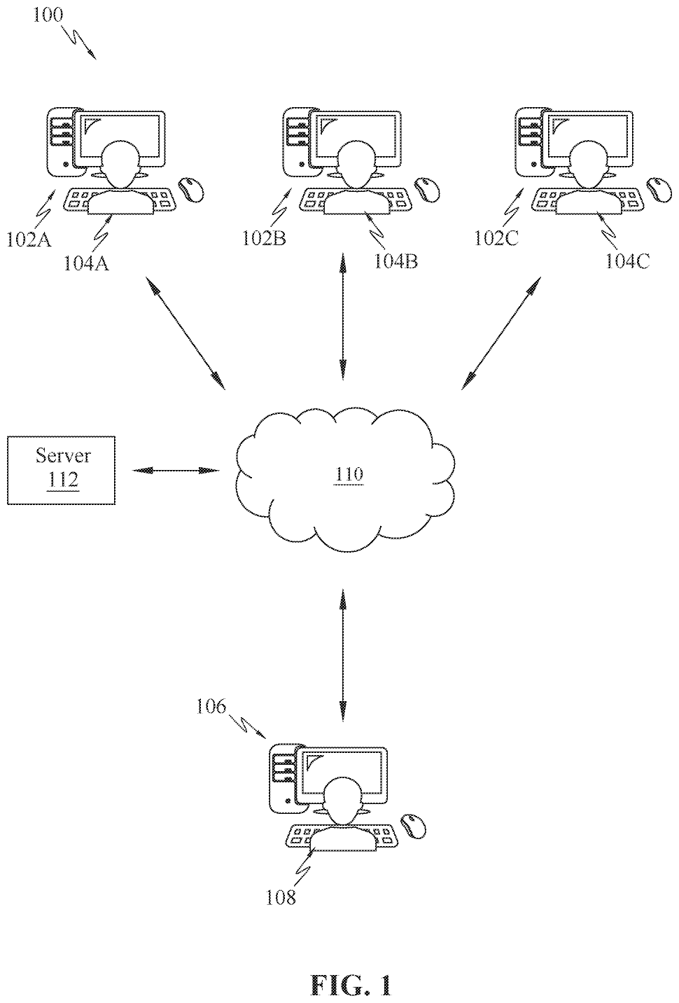

In an embodiment, the system 100 may comprise a plurality of first data processing systems 102, wherein the plurality of first data processing systems 102 are associated with a first set of users 104. Referring to FIG. 1, the plurality of first data processing modules 102 may comprise of at least three first data processing modules 102A, 102B and 102C that are associated with at least three users 104A, 104B and 104C among the first set of users 104, respectively.

In an embodiment, the system 100 may comprise of a second data processing system 106, wherein the second data processing system 106 may be associated with a second user 108, and a server 112, wherein the server 112 may be configured to organize a virtual interview and coordinate a secured connection between the first data processing systems 102, the second data processing system 106 and the server 112. The first data processing systems 102, the second data processing system 106 and the server 112 may be connected and may be configured to communicate with each other over a network 110. The network 110 may be, but not limited to, a local area network, wide area network or a metropolitan area network.

In an embodiment, the first data processing system 102 and the second data processing system 106 may be, but not limited to, a computer device, a laptop, a mobile phone and tablet, wherein the data processing systems may be configured to enable users to access the virtual interview.

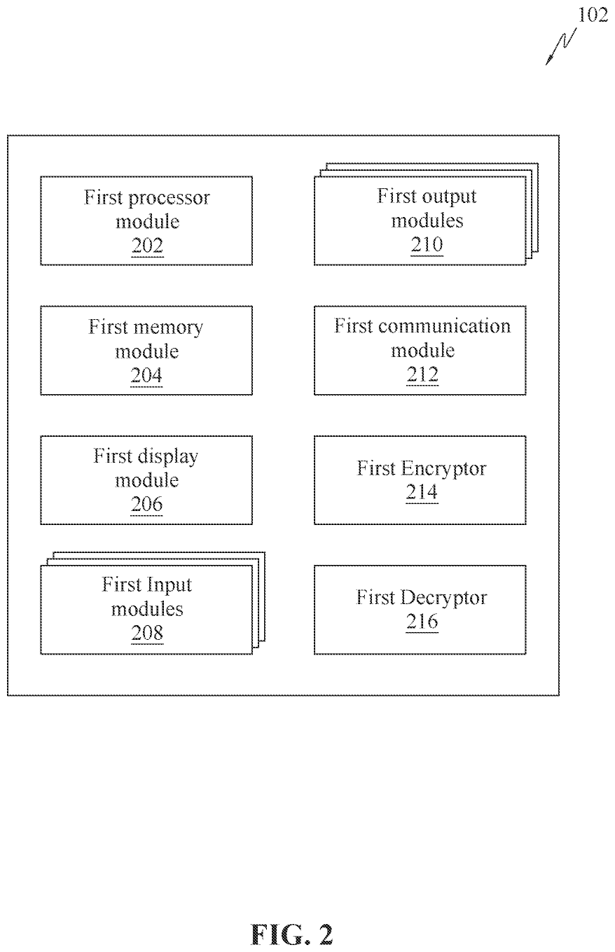

FIG. 2 is a block diagram illustrating the first data processing system 102, in accordance with an embodiment. The first data processing system 102 may comprise of a first processor module 202, a first memory module 204, a first display module 206, first input modules 208, first output modules 210, a first communication module 212, a first encryptor 214 and a first decryptor 216.

In an embodiment, the first processor module 202 may be implemented in the form of one or more processors and may be implemented as appropriate in hardware, computer-executable instructions, firmware, or combinations thereof. Computer-executable instruction or firmware implementations of the first processor module 202 may include computer-executable or machine-executable instructions written in any suitable programming language to perform the various functions described.

In an embodiment, the first memory module 204 may include a permanent memory such as hard disk drive, may be configured to store data, and executable program instructions that are implemented by the processor module. The first memory module 204 may be implemented in the form of a primary and a secondary memory. The first memory module 204 may store additional data and program instructions that are loadable and executable on the first processor module 202, as well as data generated during the execution of these programs. Further, the first memory module 204 may be a volatile memory, such as random-access memory and/or a disk drive, or a non-volatile memory. The first memory module 204 may comprise of removable memory such as a Compact Flash card, Memory Stick, Smart Media, Multimedia Card, Secure Digital memory, or any other memory storage that exists currently or may exist in the future.

In an embodiment, the first display module 206 may display an image, a video, or data to a user. For example, the first display module 206 may include a panel, and the panel may be an LCD, LED or an AM-OLED.

In an embodiment, the first input modules 208 may provide an interface for input devices such as keypad, touch screen, mouse and stylus among other input devices. In an embodiment, the first input module 208 includes a camera and a microphone.

In an embodiment, the first output modules 210 may provide an interface for output devices such as display screen, speakers, printer and haptic feedback devices, among other output devices.

In an embodiment, the first communication module 212 may be used by the first data processing system 102 to communicate with the server 112. The first communication module 212, as an example, may be a GPRS module, or other modules that enable wireless communication.

In an embodiment, first data processing system 102 may further comprise of a first encryptor 214 and a first decryptor 216. The first encryptor 214 may encrypt data being sent and first decryptor 216 may decrypt incoming data. Furthermore, the first display module 206, the first input modules 208 and the first output modules 210 may enable the interaction of the first set of users 104 with the first data processing system 102. The encrypted data from one data processing system may be transmitted to another data processing system over the communication network 110.

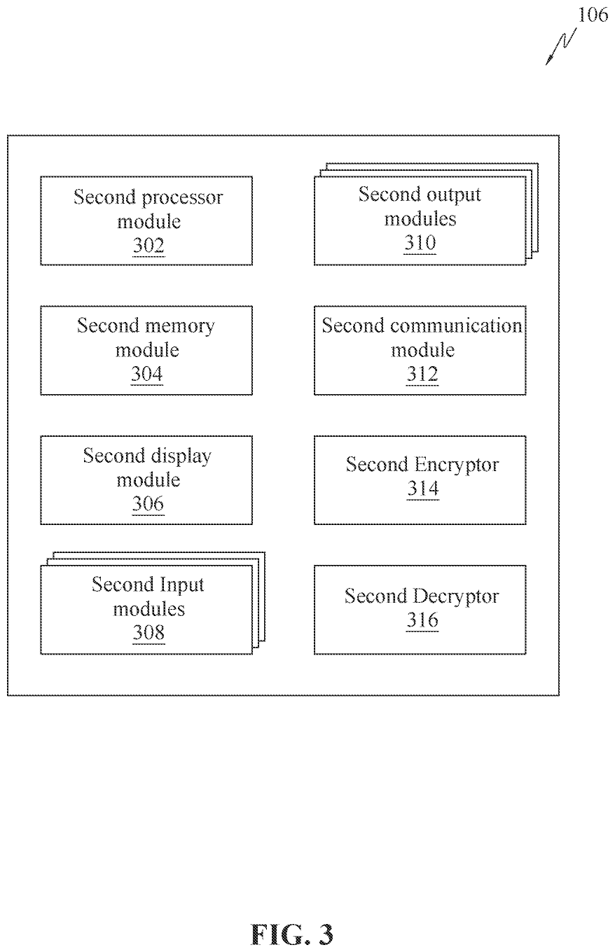

FIG. 3 is a block diagram illustrating a second data processing system 106, in accordance with an embodiment. The second data processing system 106 may comprise a second processor module 302, a second memory module 304, a second display module 306, second input modules 308, second output modules 310, a second communication module 312, a second encryptor 314 and a second decryptor 316.

It may be noted that the second data processing system 106, may have a similar architecture as that of the first data processing system 102. The second data processing system 106 is therefore not explained in detail for the sake of brevity.

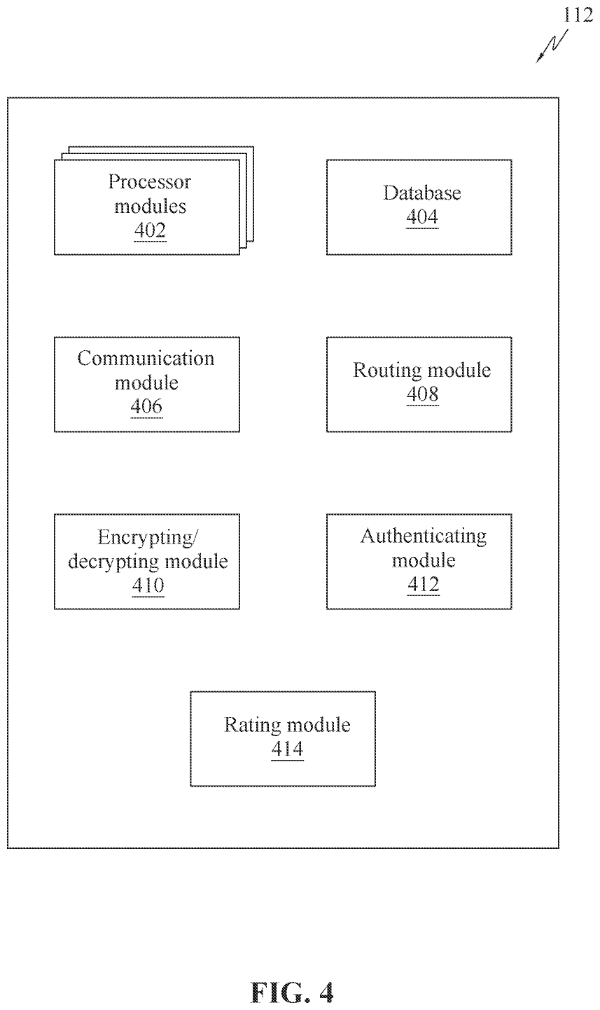

FIG. 4 is a block diagram illustrating the architecture of the server 112, in accordance with an embodiment. The server 112 may comprise a processor module(s) 402, a database 404, a communication module 406, a routing module 408, an encrypting/decrypting module 410, an authenticating module 412 and a rating module 414.

In an embodiment, the processor module 402 may be implemented in the form of one or more processors and may be implemented as appropriate in hardware, computer-executable instructions, firmware, or combinations thereof. Computer-executable instruction or firmware implementations of the processor module 402 may include computer-executable or machine-executable instructions written in any suitable programming language to perform the various functions described.

In an embodiment, the database 404 may include a permanent memory such as hard disk drive, may be configured to store data, and executable program instructions that are implemented by the processor module.

In one embodiment, the database 404 may be configured to store information related to the first user 104, the second user 108 and so on, which may not be limited to email ID, phone number of the users, information pertaining to the second data processing system 106 and so on.

In one embodiment, the communication module 406 may be used by the server 112 to communicate with the first data processing systems 102 and the second data processing system 106. The communication module 406, as an example, may be a GPRS module, or other modules that enable wireless communication.

In an embodiment, the routing module 408 may enable identification of data processing systems to which the data must be transmitted.

In an embodiment, the encrypting/decrypting module 410 may encrypt the incoming data from each of the data processing systems and decrypt the outgoing data from the server 112.

In an embodiment, the authenticating module 412 may authenticate each of the users associated with each of the data processing systems before establishing a connection.

In an embodiment, the system 100 may be configured to organize virtual interviews between the first set of users 104 and the second user 108. The first set of users 104 may comprise of an active user, a waiting user and an inactive user. The active user may be a user in the first virtual room. The waiting user may be a user waiting in the second virtual room. The inactive user is a user one who is yet to access the first virtual room or the second virtual room.

In an embodiment, the second user 108 and at least one user among the first set of users 104, that are part of the first virtual room, may be active users.

In an embodiment, the first set of users 104 may be interviewers and the second user 108 may be an interviewee. In addition, the first set of users 104 may also comprise of a host who may not be a part of the interview but may be involved in scheduling the virtual interview.

In an embodiment, system 100 may be configured to organize virtual interviews, wherein the system 100 comprises of the server 112 that may be provided with the processor module 402, wherein the processor module 402 may be configured to create a first virtual room, and a second virtual room associated with the first virtual room.

The server 112 may be configured to create an agenda for the second user 108 and the first set of users 104 based on inputs received by at least one user among the first set of users 104A, 104B or 104C, wherein the agenda may comprise of at least one interactive session, wherein each interactive session may have at least one time slot assigned to at least one of the first set of users 104A, 104B or 104C and the second user 108.

In an alternate embodiment, based on inputs received from first set of users 104, an agenda comprising a plurality of interactive sessions may be created, wherein each interactive session may be assigned with a time slot.

In an embodiment, the server 112 may be further configured to communicate respective assigned time slots with each of the first set of users 104, create a unique virtual address for the first virtual room and the second virtual room, wherein the unique virtual address may enable the second user 108 and at least one user among the first set of users 104A, 104B or 104C to access at least the second virtual room wherein access to the second virtual room is for a respective time slot for the second user 108 and at least one user among the first set of users 104A, 104B or 104C.

In an embodiment, the unique virtual address may enable at least one user among the first set of users 104 to access the first virtual room directly without accessing the second virtual room first.

The server 112 may be configured to communicate the agenda and the unique virtual address with the second user 108 and the first set of users 104, host the first virtual room and the second virtual room and provide access to at least one user among the first set of users 104A, 104B or 104C with respective assigned time slot to the first virtual room. The server 112 may be configured to provide access to the second user 108 to the second virtual room upon establishing a connection between the server 112 and the second data processing system 106, wherein the second data processing system 106 may be associated to the second user 108.

The server 112 may be further configured to provide the second user 108 access to the first virtual room upon establishing a connection between the first data processing system 106 and the second data processing system 106 and receiving a first instruction from at least one active user among the first set of users 104A, 104B or 104C to enable interaction between the active user and the second user 108, wherein the first data may be associated to at least one user among the first set of users 104 (i.e., when a user among the first set of users 104 and the second user 108 access the unique virtual address for joining the virtual room) and notify at least one user among the first set of users 104A, 104B or 104C of conclusion of interaction between the active user and the second user 108 upon receiving a second instruction from the active user and thereby provide access to at least one subsequent user among the first set of users 104A, 104B or 104C, into the first virtual room to establish interaction with the second user 108, wherein the active user may provide access to the at least one subsequent user among the first set of users 104A, 104B or 104C with the assigned time slot to join the first virtual room. Status of the subsequent user among the first set of users 104A, 104B or 104C, upon entering the first virtual room, changes to active user.

In an embodiment, the interaction between the active user and the second user 108 in the first virtual room is by way of a video call, a voice call or a chat.

In an embodiment, the first instruction may correspond to, but not limited to, at least one active user granting access to the second user 108 to join the first virtual room.

In an embodiment, the second instruction may correspond to, but not limited to, at least one active user granting access to the at least one subsequent user among the first set of users 104 to join the first virtual room.

In an embodiment, the server 112 may be configured to notify the waiting user or the inactive user of conclusion of interaction between the active user and the second user 108 by way of email, text message or a phone call upon receiving the second instruction.

In an embodiment, the server 112 may be further configured to notify the waiting user or the inactive user the status of interaction between the active user and the second user 108. The server 112 may be configured to notify the waiting user or the inactive user regarding time elapsed since the interaction between the active user and the second user commenced. By this way the waiting user or the inactive user gets the updates on the status of the interaction.

In an embodiment, the server 112 may be further configured to notify the waiting user or the inactive user a reminder of their assigned time slot.

In an embodiment, the server 112 may be configured to transfer host controls of the first virtual room and the second virtual room from one active user to subsequent active user upon receiving a third instruction from at least one former active user.

In an embodiment, the third instruction may correspond to, but not limited to, at least one active user transferring the host controls of the first virtual room and the second virtual room to any of the subsequent active user among the first set of users 104.

In an embodiment, the server 112 may be configured to transfer host controls of only one of the first virtual room or the second virtual room from one active user to subsequent active user upon receiving an instruction from at least one former active user.

In an embodiment, the rating module 414 of the server 112 may be configured to receive ratings for the second user 108 from at least one user among the first set of users 104A, 104B or 104C. The server 112 may be further configured to consolidate the ratings, in case the ratings are received from multiple first set of users 104 and generate a final report with the consolidated ratings for the second user 108. The server 112 may be configured to communicate the ratings to at least one user among the first set of users 104A, 104B or 104C.

In an embodiment, the server 112 may be configured to enable interaction between multiple users among the first set of users 104 in the second virtual room by way of a video call, a voice call or a chat.

In an embodiment, the server 112 may be configured to enable interaction between the first set of users 104 in the first virtual room and the first set of users 104 in the second virtual room by way of a video call, a voice call or a chat.

In an embodiment, the server 112 may be configured to restrict the second user 108 from interacting with any of the first set of users 104, while both the second user 108 and the first set of users 104 are in the waiting room.

In an embodiment, the server 112 may be configured to provide access to a subsequent user among the first set of users 104 to the first virtual room, in case the user among the first set of users 104 for the assigned time slot is unavailable. In cases where a user among the first set of users 104 with the assigned time slot is unavailable, any subsequent user among the first set of users 104 who is available at the instant time may be provided access to the first virtual room irrespective of the users assigned time slot.

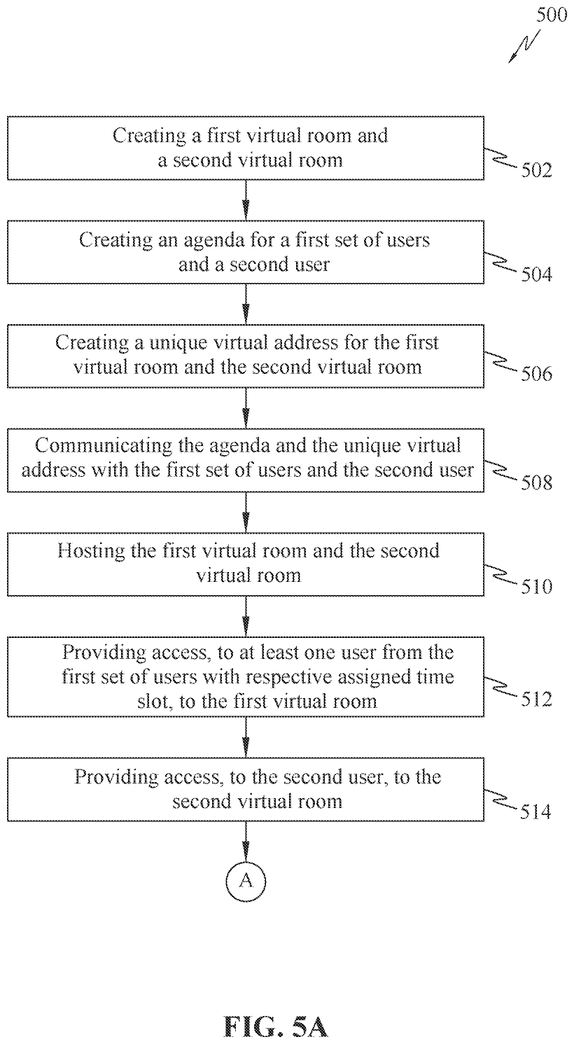

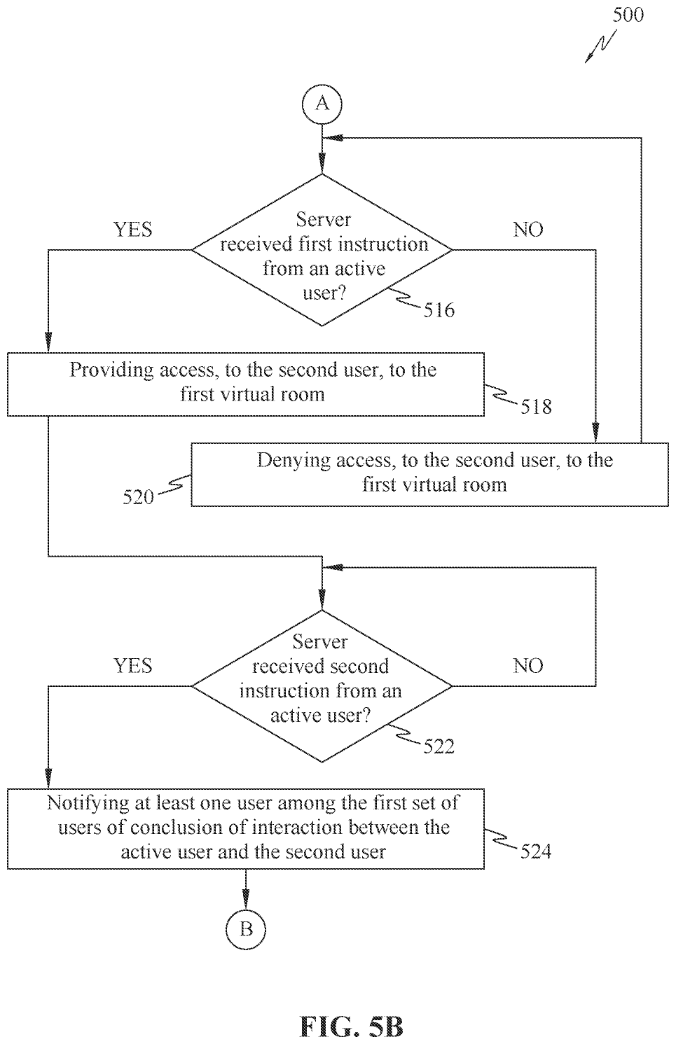

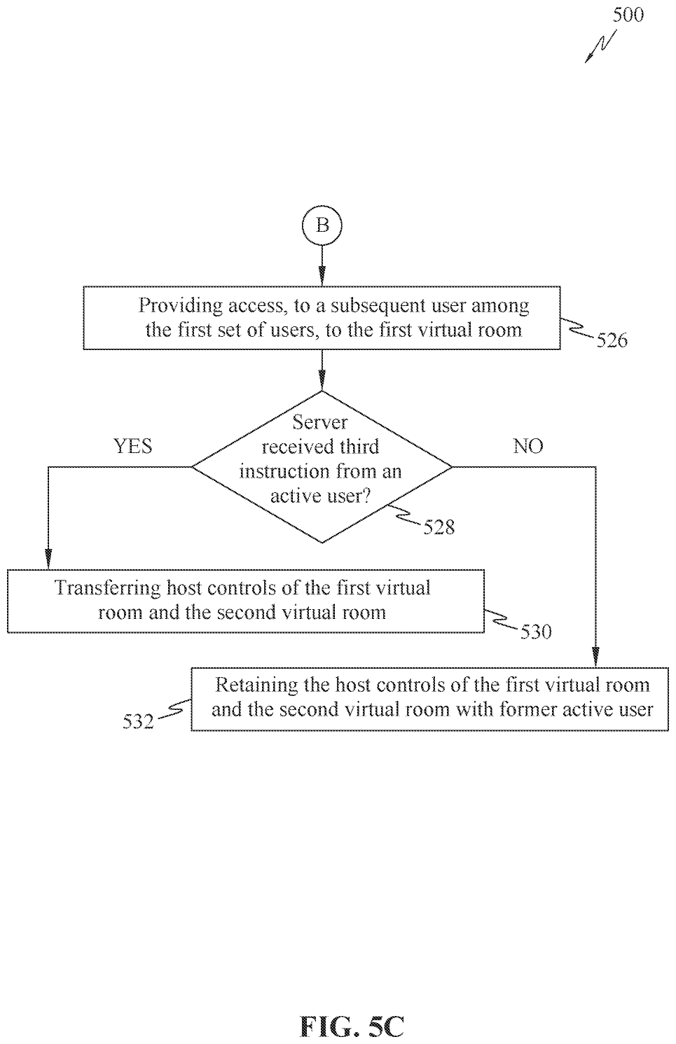

FIGS. 5A-5C are flowcharts 500 illustrating the working of the system 100, in accordance with an embodiment.

At step 502, the server 112 may be configured to create a first virtual room and a second virtual room. The server 112 may be configured to create the first virtual room and the second virtual room based on inputs received from at least one user among the first set of users 104. The second virtual room may be associated with the first virtual room. For example, a host or one user among the first set of users 104 provide inputs to the server 112 relating to an interview to be organized and conducted. Based on the inputs received from at least one user among the first set of users 104, the server 112 is configured to create the first virtual room and the second virtual room, wherein the first virtual room corresponds to a main space that is configured to enable interaction between the second user 108 and the first set of users 104, and the second virtual room corresponds to a waiting space for any user for waiting before the user is provided access to the first virtual room.

At step 504, the server 112 may be configured to create an agenda for the second user 108 and the first set of users 104. The server 112 may be configured to create the agenda for the second user 108 and the first set of users 104 based on the inputs received from at least one user among the first set of users 104. For example, the host or one user among the first set of users 104 provides additional inputs to the server 112 regarding the interview to be organized and conducted. The additional inputs comprise details like, but not limited to, number of users forming the first set of users 104, Email ID or phone numbers of the second user 108 and users forming the first set of users 104, among others. In addition, the host or one user among the first set of users 104 can provide details for the agenda like, but not limited to, number of interactive sessions in each interview, time slot assigned for each of the interactive session and details of the second user 108 and the first set of users 104 to whom the interactive sessions are to be assigned.

At step 506, the server 112 may be configured to create a unique virtual address for the first virtual room and the second virtual room, wherein the unique virtual address enables the second user 108 and at least one user among the first set of users 104 to access at least the second virtual room, wherein access to the second virtual room is for a respective time slot for the second user 108 and at least one user among the first set of users 104. For example, the unique virtual address allows the second user 108 and each user among the first set of users 104 to access the second virtual room or the first virtual room for a dedicated duration of time.

At step 508, the server 112 may be configured to communicate the agenda and the unique virtual address with the second user 108 and the first set of users 104. For example, once the server 112 creates the agenda for the interview along with the unique virtual address, the server 112 is then configured to communicate the created agenda and the unique virtual address with the second user 108 and the first set of users 104. The second user 108 and the first set of users 104 can access the second virtual room or the first virtual room using the unique virtual address. Furthermore, if each interview comprises of multiple interactive sessions, wherein each interactive session is assigned to different user among the first set of users 104, details of the respective interactive session is communicated with the respective user among the first set of users 104. Similarly, the second user 108 may be communicated with the details of the interview.

At step 510, the server 112 may be configured to host the first virtual room and the second virtual room.

At step 512, the server 112 may be configured to provide at least one user among the first set of users 104, with the respective assigned time slot, access to the first virtual room. For example, if each interview comprises of multiple interactive sessions with respective assigned time slots for the first set of users 104, the user among the first set of users 104 to whom the respective interactive session with the respective time slot is assigned is provided access to the first virtual room. Multiple users among the first set of users 104 may be provided access to the first virtual room, if multiple users among the first set of users 104 are assigned for the same interactive session.

At step 514, the server 112 may be configured to provide access to the second user 108 to the second virtual room on establishing a connection between the server 112 and the second data processing system 106, wherein the second data processing system 106 is associated to the second user 108. Here, once the second user 108 uses the unique virtual address to join the interview, a connection is first established between the second data processing system 106 associated with the second user 108 and the server 112 and thereafter the second user 108 is provided access to the second virtual room.

At step 516, the server 112 may be configured to determine if a first instruction is received from an active user.

At step 518, if the server 112 receives the first instruction from the active user, the server 112 may be configured to provide access to the second user 108 to the first virtual room on establishing a connection between the first data processing system 102 and the second data processing system 106, wherein the first data processing system 102 is associated to the first set of users 104. For example, the second user 108 waiting in the second virtual room, requests the active user to join the first virtual room. Upon receiving an approval from the active user, the server 112 grants the second user 108 access to the first virtual room. Once the second user 108 joins the first virtual room, the active user(s) among the first set of users 104 and the second user 108 can interact with each other.

At step 520, if the server 112 does not receive the first instruction from the active user, the server 112 may be configured to deny the second user 108 access to the first virtual room.

At step 522, the server 112 may be configured to determine if second instruction is received from an active user.

At step 524, the server 112 may be configured to notify at least one user among the first set of users 104 of conclusion of interaction between the active user and the second user 108. For example, during the virtual interview process, if the current active user concludes his part of the interview, the active user sends the second instruction to the server 112, wherein the server 112 then notifies at least one user among the first set of users 104 of conclusion of interaction between the active user and the second user 108.

If the server 112 does not receive the second instruction from the active user, process goes back to step 522, where the server 112 is configured to determine if the second instruction is received from an active user.

At step 526, the server 112 may be configured to provide access to a subsequent user among the first set of users 104 to the first virtual room. For example, once the current active user concludes their part of the interview, the server 112 is configured to provide the subsequent user among the first set of users 104 access to the first virtual room, wherein status of the subsequent user joining the first virtual room changes to active user. Once subsequent users among the first set of users 104 are notified of conclusion of the interaction between the active user and the second user 108, the subsequent user with the respective assigned time slot is provided access to the first virtual room. The current active user, who sent the second instruction to the server 112 may remain in the first virtual even after the subsequent user among the first set of users 104 joins the first virtual room or may leave the first virtual room.

At step 528, the server 112 may be configured to determine if third instruction is received from an active user.

At step 530, the server 112 may be configured to transfer host controls of the first virtual room and the second virtual room from current active user to the subsequent active user among the first set of users 104 upon receiving the third instruction from at least one former active user, wherein the third instruction corresponds to at least one active user transferring the host controls to any of the subsequent active user among the first set of users 104.

If the server 112 does not receive the third instruction from the least one former active user, at step 532, the host controls of the first virtual room and the second virtual room are retained with the former active user.

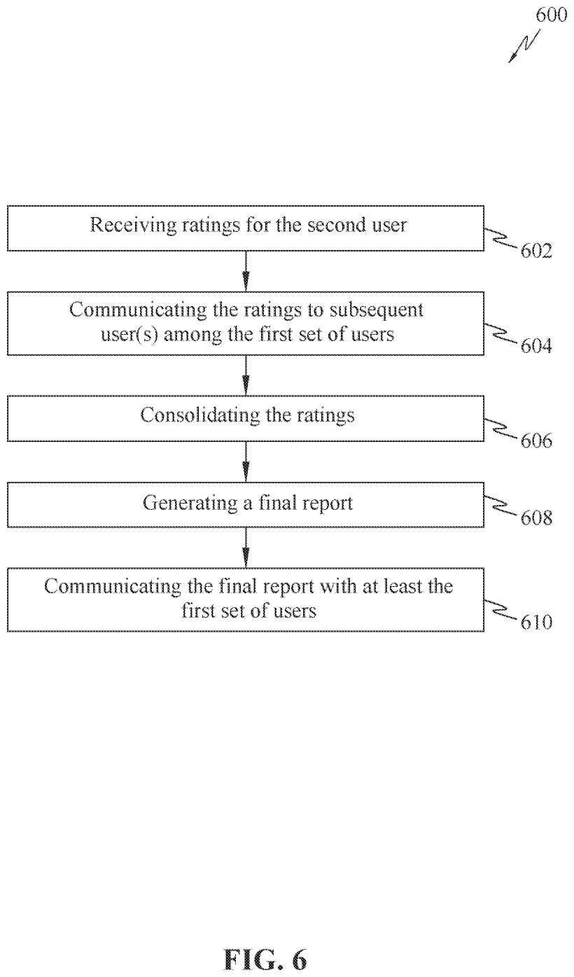

FIG. 6 is a flowchart 600 illustrating a process of rating the second user 104 by the first set of users 104, in accordance with an embodiment.

At step 602, the server 112 may be configured to receive ratings for the second user 108 from at least one user among the first set of users 104. For example, during the interview process, wherein the active user and the second user 108 are interacting with each other in the first virtual room, the active user may rate the second user 108 based on the performance of the second user 108. Similarly, multiple users of the first set of users 104 may provide ratings for the second user 108 based on the performance.

In an embodiment, ratings may be provided in different ways viz., but not limited to, rating on the scale of 1-10, 1 being “poor” performance and 10 being the “best”. Furthermore, the first set of users 104 may be provided with multiple fields for rating the second user 108, wherein multiple fields relate to, but not limited to, vocabulary, knowledge, attire, body language and communication. The fields may be customizable based on the requirement. Ratings may also be provided by way of text feedback.

At step 604, the server 112 may be configured to communicate the ratings to the subsequent user(s) among the first set of users 104. For example, ratings provided by active user among the first set of user(s) 104 are communicated with at least the subsequent user(s) among the first set of users 104, wherein the subsequent user(s) can include waiting user(s) or inactive user(s). This enables the subsequent user among the first set of users 104 to refer to the ratings former active user among the first set of users 104 has provided for the second user 108.

At step 606, the server 112 may be configured to consolidate the ratings received from different users among the first set of users 104. The server 112 is configured to retrieve all the ratings provided by all the users of the first set of users 104 and consolidate the ratings.

At step 608, the server 112 may be configured to generate a final report based on the consolidated ratings. The final report generated by the server 112 comprises of all the ratings each of the first set of users 104 has provided in each field for the second user 108. The server 112 may be further configured to generate an average rating for the second user 108 based on the ratings received from first set of users 104.

At step 610, the server 112 may be configured to communicate the final report with at least the first set of users 104. The final report generated may be communicated with the second user 108 and the first set of users 104. This enables the first set of users 104 to take a final decision. Communicating the final report with the second user 108 enables the second user to analyse their performance in the said interview.

It shall be noted that the processes described above are described as sequence of steps; this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus, the scope of the invention should be determined by the appended claims and their legal equivalents rather than by the examples given.

What is claimed is:

1. A system for organizing a virtual interview, the system comprising:
a server comprising at least one processor module configured to:
create a first virtual room and a second virtual room associated with the first virtual room;
create an agenda for a second user and a first set of users based on inputs received by at least one user among the first set of users, wherein,
the agenda comprises of at least one interactive session;
each interactive session is assigned a time slot; and
each interactive session is assigned to the second user and at least one of the first set of users;
create a unique virtual address for the first virtual room and the second virtual room, wherein,
the unique virtual address enables the second user and at least one user among the first set of users to access at least the second virtual room; and
access to the second virtual room is for a respective time slot for the second user and at least one user among the first set of users;
communicate the agenda and the unique virtual address with the second user and the first set of users;
host the first virtual room and the second virtual room;
provide at least one user among the first set of users, access to the first virtual room;
provide the second user, access to the second virtual room upon establishing a connection between a second data processing system and the server, wherein the second data processing system is associated to the second user;
provide the second user, access to the first virtual room upon establishing a connection between a first data processing system and the second data processing system and receiving a first instruction from at least one active user among the first set of users to enable interaction between the active user and the second user, wherein the first data processing system is associated to at least one user among the first set of users;
notify at least one user among the first set of users of conclusion of interaction between the active user and the second user upon receiving a second instruction from the active user and thereby provide access to at least one subsequent user among the first set of users, into the first virtual room to establish interaction with the second user, wherein,
the active user provides access to the at least one subsequent user among the first set of users to join the first virtual room; and
status of the subsequent user among the first set of users, upon entering the first virtual room, changes to active user; and
transfer host controls of the first virtual room and the second virtual room from one active user to subsequent active user upon receiving a third instruction from at least one former active user.

2. The system according to claim 1, wherein the server is configured to provide access to the at least one subsequent user among the first set of users with the assigned time slot to join the first virtual room.

3. The system according to claim 1, wherein the server comprising a rating module is configured to:
receive ratings from at least one active user among the first set users, for the second user; and
communicate the ratings to the at least one user among the first set of users.

4. The system according to claim 3, wherein the server is configured to:
consolidate the ratings shared by the first set of users; and
generate a final report.

5. The system according to claim 1, wherein the active user is the one who is in the first virtual room.

6. The system according to claim 5, wherein the server is configured to notify a waiting user the conclusion of the interaction between the active user and the second user by way of email, text message or a phone call, wherein the waiting user is the one waiting in the second virtual room.

7. The system according to claim 6, wherein the server is configured to notify the waiting user:
status of the interaction between the active user and the second user; or
reminder of the assigned time slot for the waiting user.

8. The system according to claim 5, wherein the server is configured to notify an inactive user the conclusion of the interaction between the active user and the second user by way of email, text message or a phone call, wherein the inactive user is the one who is yet to access the first virtual room or the second virtual room.

9. The system according to claim 8, wherein the server is configured to notify the inactive user:
status of the interaction between the active user and the second user; or
reminder of the assigned time slot for the inactive user.

10. The system according to claim 1, wherein the interaction between the active user and the second user in the first virtual room is by way of a video call, a voice call or a chat.

11. The system according to claim 1, wherein the second user is restricted from interacting with any of the first set of users while both the first set of users and the second user are waiting in the second virtual room.

12. The system according to claim 1, wherein the server is configured to:
enable interaction between multiple users among the first set of users in the second virtual room by way of a video call, a voice call or a chat; and
enable interaction between the first set of users in the first virtual room and the second virtual room by way of a video call, a voice call or a chat.

13. The system according to claim 1, wherein the first instruction corresponds to at least one active user granting access to the second user to join the first virtual room.

14. The system according to claim 1, wherein the second instruction corresponds to at least one active user granting access to the at least one subsequent user among the first set of users to join the first virtual room.

15. The system according to claim 1, wherein the third instruction corresponds to at least one active user transferring the host controls to any of the subsequent active user among the first set of users.

16. The system according to claim 1, the server is configured to provide subsequent user among the first set of users, access to the first virtual room, in case the user among the first set of users for the assigned time slot is unavailable.

17. A computer-implemented method for conducting virtual interviews, wherein a server is configured to execute the following steps:
creating a first virtual room and a second virtual room associated with the first virtual room;
creating an agenda for a first set of users and a second user based on inputs received by at least one user among the first set of users, wherein,
the agenda comprises of at least one interactive session;
each interactive session is assigned with a time slot; and
each interactive session is assigned to the second user and at least one of the first set of users;
creating a unique virtual address for the first virtual room and the second virtual room, wherein,
the virtual address enables the second user and at least one user among the first set of users to access at least the second virtual room; and
access to the at least second virtual room is for a respective time slot for the second user and at least one user among the first set of users;
communicating the agenda and the unique virtual address with the second user and the first set of users;
hosting the first virtual room and the second virtual room;
providing at least one user among the first set of users, access to the first virtual room;
providing the second user, access to the second virtual room upon establishing a connection between the server and a second data processing system, wherein the second data processing system is associated to the second user;
providing the second user, access to the first virtual room upon establishing a connection between a first data processing system and the second data processing system and receiving a first instruction from at least one active user among the first set of users to enable interaction between the active user and the second user, wherein the first data processing system is associated to at least one user among the first set of users;
notifying at least one user among the first set of users of conclusion of interaction between the active user and the second user upon receiving a second instruction from the active user and thereby providing access to at least one subsequent user among the first set of users, into the first virtual room for establishing interaction with the second user, wherein,
the active user provides access to the at least one subsequent user among the first set of users to join the first virtual room; and
status of the subsequent user among the first set of users, upon entering the first virtual room, changes to active user; and
transferring host controls of the first virtual room and the second virtual room from one active user to subsequent active user upon receiving a third instruction from at least one former active user.

18. The method according to 17, comprising:
receiving ratings, from at least one active user among the first set of users, for the second user; and
communicating the ratings to at least one user among the first set of users.

19. The method according to 17, comprises consolidating the ratings shared by the first set of users and generating a final report.

20. The method according to claim 17, wherein:
the first instruction corresponds to at least one active user granting access to the second user for joining the first virtual room;
the second instruction corresponds to at least one active user granting access to subsequent user among the first set of users to join the first virtual room; and
the third instruction corresponds to at least one active user transferring the host controls to any of the subsequent user among the first set of users.
